(19) United States
(12) Patent Application Publication
(10) Pub. No.: US 2012/0116857 A1
(43) Pub. Date: May 10, 2012

(54) System And Method For Converting Points Linked With Purchases Using Card Transactions Into Annuities

(75) Inventors: Hikaru Deguchi, Tokyo (JP); Yoshikazu Takasaki, Tokyo (JP)

(73) Assignees: MEKIKI CREATES CO., LTD., Tokyo (JP); MEKIKI CO., LTD., Tokyo (JP)

(21) Appl. No.: 13/148,276

(22) PCT Filed: Feb. 8, 2010
(86) PCT No.: PCT/JP2010/051782

§ 371 Date: Oct. 24, 2011

(30) Foreign Application Priority Data
Feb. 6, 2009 (JP) 2009-026801
Oct. 20, 2009 (JP) 2009-241040

(51) Int. Cl. G06Q 30/02

(52) U.S. Cl. 705/14.18

(57) ABSTRACT

Disclosed are a system and a method for accumulating, as funds for individual annuities for each customer, points acquired as a result of goods purchased at participating stores by customers who have concluded contracts to make payments by credit card. A system management computer (1) can communicate with terminals (4) of participating stores and comprises a contract holder information database that stores attributes of contract holders, a participating store information database that stores attributes of the participating stores and participating store point reduction rates, and an annuity-conversion point information database that stores information pertaining to funds for individual saved annuities. The computer also comprises a means for receiving purchase information that includes the IDs of the contract holder who purchased the goods and of the participating store along with the purchase price from a terminal (4) of a participating store, a means for calculating the participating store points by multiplying the purchase price with the point reduction rate for said participating store, and a means for adding said calculated participating store points to the annuity-conversion point total that is stored in the annuity-conversion point information database associated with the ID of said contract holder and updating the annuity-converted point total.

### TECHNICAL FIELD

The present invention relates to a system and a method accumulating points according to each guest as a resource of a private annuity when guests who contracted credit-card transactions purchase an item at a member store

### BACKGROUND ART

There has been an increasing number of business operators adopting a loyalty program and providing a point with a guest according to purchased amount of an item as part of customer service.

This service can give benefits to the guest such as giving them a free gift, exchanging the point with a gift voucher which can be used at their stores and so on when the number of point meets the certain points.

“A system accumulating a private annuity relating to credit-card transactions” disclosed in Patent Document 1 is the invention which stores the point obtained by the guest at the system as a private annuity in the future. When they join the generation of the elderly, they can get a private annuity which is derived from the point accumulated originally aside from public annuity. The users of this system can also get an economic security in the future as well as enjoy shopping by credit cards.

In addition, the idea of consuming in youth to prepare for old age is also shown in Patent Documents 2 and 3.
[Patent Document 1] Patent Application Publication No.2002-366767
[Patent Document 2] Patent Application Publication No.2007-87360
[Patent Document 3] Patent Application Publication No.2007-157098

### DISCLOSURE OF THE INVENTION

### Problems the Invention is Intended to Solve

Since accumulating an annuity is a kind of savings, the invention described in Patent Document 1 can expect the system users to take a balanced action which has consumptions and savings at the same time. It is also significant in terms of nation's economy as domestic demand expansion.

However, the invention described in Patent Document 1 does not show means for dealing with the points together when a plurality of operating bodies adopt loyalty programs.

Moreover, when consumers shop at participating providers with credit cards, they often obtain the both of points issued by participating providers and credit-card companies, however, the invention described in Patent Document 1 does not consider these two kinds of points.

Furthermore, some providers might desire the point issued by them to be used for exchanging them for their products not for accumulating the annuity. The invention described in Patent Document 1 does not consider the convenience for these providers.

The present invention was contrived in view of the above, and an object thereof is to deal with the points together when a plurality of operating bodies adopt loyalty programs and deal with the points issued by providers and by system operators such as credit-card companies together

At the same time, another object thereof is to provide a system where Providers which adopt their own loyalty programs can join easily to ensure discretions where each provider can convert the rate of redeeming points or the rate of commission paid to system operators.

### Means for Solving the Problems

To achieve the foregoing objects, the invention according to claim 1 includes:

a system converting a point into an annuity for accumulating a point of a member store according to each guest as a resource of a private annuity when a customer contacted credit-card transactions (hereinafter called “contractant” purchases an item at the member store and paying an amount after deduction of contractant points from purchased amount to the member store comprising:

a system managing computer of this system capable of connecting with a member store terminal used by the member store via communication network;

a contractant information database storing attribute information of the contractant (For example, authentication information such as name, address, date of birth, information of an account to charge a purchase price, and password);
a member store information database storing attribute information of the member store (For example, name, location, information of an account to charge) and a rate of redeeming of point of the member store;

an information database of a point converting into an annuity storing information regarding a resource of a private annuity accumulated;

a contractant purchase information receiving device receiving purchase information including a purchase price as well as a contractant ID of the contractant purchasing an item and a member store ID of the member store from the member store terminal;

a member store point calculating device reading the rate of redeeming point of the member store linked the member store ID and multiplying by said purchase price to calculate the member store points: and

an annuity point managing device adding a balance of the point converting into an annuity stored in the information database of a point converting into an annuity linked the contractant ID of the contractant to the member store points to update the balance of the point converting into the annuity.

“A contrantant who contracted credit-card transactions” is mainly supposed to be a consumer whom a credit-card company issued a credit card to and who use this credit card to make a purchase. However, not only credit cards but also debit cards, electronic money, deposit cards and so on can apply to this system.

“A member store” includes not only actual stores but also internet shopping sites. “An item” includes not only tangible items but also intangible items (services).

“A point” means valuable value information which can be redeemed items or cash voucher. For example, 1 unit (1 point) is equivalent to 1 yen.

“A private annuity” is similar to a public pension such as an employee pension and a national pension, and a personal pension insurance which is an item provided by a life assurance company in that a cost is accumulated for a prolonged period and the reserved amount can be available in the future especially after being old.

“A system managing computer” is a computer which is used by an administrative operator. As for the administrative operator, a card issuer as typified by a credit-card company is supposed. However, an operator of Social Network Services (hereinafter called SNS) or an operator of internet shopping malls can be the administrative operator of this system. In this case, the operators of the SNS or the internet shopping malls may issue their own credit cards or they can cooperate with credit-card companies for issuing credit cards.

In the latter situation, this system is applied when a user buys something at said internet shopping mall using the credit card issued by this credit-card company. In short, in so far as this system accumulates points acquired by the consumer who shops by credit-card transactions, the administrative operator is not particularly limited.

“The rate of redeeming points” refers to the rate which is returned to a contractant out of the price as points.

If 1 yen is equivalent to 1 point converted as the figures, when 5 points are obtained per 100 yen of expense, it means that the rate of redeeming points is 5% (=5 yen/100 yen) since 5 yen will be returned at a shopping of 100 yen,

Here are FIG. 8 showing an existing point service and FIG. 9 a point service of present system. In FIG. 8, a consumer pays the purchase price by credit-card transactions. The point linked to the purchase price (P1) is given to the consumer directly. The point (P1) can be used as a discount of purchasing an item at said member store, or exchanging the point for the cash voucher which can be only used for purchasing an item at said member store etc. In this way, the point (P1) is often limited in its use.

A credit-card company pays the amount of money after deduction of a commission from a purchase price of an item to member stores. Some credit-card companies give a card point (P2) as a benefit to a consumer who used the credit card. This card point (P2) is also often limited in its use of the invitation to restaurant services.

On the other hand, in FIG. 9 which shows the point service of the present invention, the consumer pays the purchased price by credit-card transaction. The amount of money after deduction of a point linked to the purchased price (P3) and the commission of a credit-card company is paid to the member store.

Next, FIG. 8 and FIG. 9 are weighed.

The point (P1) in FIG. 8 is issued and managed by the point service system provided at the member stores separately without any relation to systems of credit-card companies and so on. Therefore, the burden on the member stores is great. Although it is useful for promotion, it can be difficult for them to adopt the point services. Furthermore, when the point services is terminated due to a closure of the member stores and so on, the burden on them is great since it will be needed to execute after-processing such as make a contact with customers.

However, in the service of a point converting into an annuity of the present invention, the point in FIG. 9 (P3) is deducted from the purchased price by point transaction of the systems provided by credit card companies, SNS and so on, or credit cards transaction. Only the system of credit-card companies and so on can issue and manage this point (P3). The member stores bear a financial burden equivalent to the amount of the points (P3). However, they don't have to issue their own point cards by themselves. Therefore, the member stores can provide customers the point service almost without bearing manpower or costs in terms of the operation of point-service systems. The switch from the point services of one-of-a-kind member stores to the services of converting points into annuities of the present invention can be available easily by just notifying the system and being registered. In the same manner, the withdrawal from membership of the services of converting points into annuities of the present invention can be available easily by just notifying the system and being registered.

Furthermore, in the present invention, the points of member stores are handled uniformly as resources of private annuity in principle. The systems of credit-cards companies and so on do not need to handle the points of member stores separately according the member stores. It is easy to operate and maintain the system. Of course, the rate of redeeming points may be different according to member stores. In this case, the system memorizes the member stores linking with the rates of redeeming points and manages them.

On the other hand, unlike existing point service which is often limited their uses, the contractants can accumulate the points which are converted into the amount of money in accounts configured for themselves in the present invention. The points issued by purchasing items are accumulated successively in accounts. The points obtained in a member store where the customer visited only once can also be accumulated in accounts. Moreover, this is the system allows member stores not to issue their own point cards. The contractants are freed from taking many point cards issued by member stores in their wallets. Existing point services had a problem regarding the re-issue of the point cards when they were lost. However, the present invention does not need any point cards. The problem does not arise.

In order to achieve the objects above-mentioned, the invention according to claim 2 comprising:

said member store information database also memorizing a rate of a commission paid by each of the member store to a card holder;

said system managing computer calculating the commission by adding said rate of the commission to said purchased price;

a card point calculating device calculating a card point adding the commission to prescribed rate of redeeming card point, wherein

said annuity point managing device adding a present balance of an amount of an annuity point memorized in said annuity point information database to a total said member store point and said card point to update the present balance of the amount of the annuity point.

The member store pays prescribed rate of a price as a commission to a card issuer. For example, when the commission is supposed to be 5% of the price, this 5% is equivalent to “the rate of the commission”.

The card holder usually receives a commission from a member store and gives a contractant points from the commission received. This is the point in FIG. 8 (P2) and the point in FIG. 9 (P4). For example, when the commission is 100 yen and the rate of redeeming card point is 20%, the card point is 20 yen (100 yen times 20% is 20 yen.). Existing card point (P2) is often redeemed as a form of a privilege such as meals or accommodations. However, a point of the present invention (P4) is accumulated in a financial institution or a SNS operator etc converting into the amount for a contractant. The point accumulated is not limited its use since it is tantamount to a long-period deposit and saving. The point accumulated is more convenient than the existing card point.

In order to achieve the objects above-mentioned, the invention according to claim 3 comprising:

said annuity point amount being managed to be deposited in an account of a financial institution, said account of a financial institution is opened for each contractant.

The invention according to claim 4 comprising:

said annuity point amount being deposited in a lump in an account of a financial institution,

said account of the financial institution being opened by said system,

a variation of the annuity point amount of each of the contractant being managed on said annuity point information database.

In this way, the system of the present invention can manage the point vested in a contractant surely.

“Said account of the financial institution is opened by said system” according to claim 4 is not limited to an account dedicated to the system of the present invention. For example, a regular deposit and saving account can be used. In a book, a deposit is dealt as a debtor and a saving from a contractant is dealt as creditor. The variation of a point amount can be managed on a database. That is, a present balance of a point amount of each contractant can be always found out. It is important for the contractant that the balance is stored reliably in order to be withdrawn in the future.

In order to achieve the objects above-mentioned, the invention according to claim 5 comprising:

said member store information database comprising a point annuity flag linked with member store ID,

the point annuity flag is set TRUE when a point issued by said member store is converted into an annuity by said point annuity system is allowed and FALSE when a point issued by said member store is converted into an annuity by said point annuity system is not allowed;

said member store point calculating device calculating the member store point only when the point annuity flag is set TRUE.

In this way, a store which agrees to convert a point into an annuity by the present invention and a store which does not agree to convert a point into an annuity by the present invention both can be member stores. Some member stores may hope the clients to use a point issued by the member stores in order to purchase or exchange items of the member stores.

However, in the present invention, the member stores can adopt a point service of the system and carry out a point service of their own at the same time. The customer can choose either of them freely.

In order to achieve the objects above-mentioned, the invention according to claim 6 comprising:

said system managing computer receiving a change of the rate of redeeming points notified from a member store terminal,

a rate of redeeming point renewal device updating said member store information database to a content received.

In this way, the member store can do a promotion or acquire more customers by changing the rate of redeeming points properly. For example, during a season of midsummer gift (Otyugen) or year-end gift (Oseibo), they can increase the rate of redeeming points compared to other seasons.

In order to achieve the objects above-mentioned, the invention according to claim 7 comprising:

said system managing computer further comprising a purchase information database memorizing an item purchase information comprising a member store ID and a contractant ID linked with a purchase ID;

a usage detail notification device notifying use information of the system comprising an annuity point amount extracted from said annuity point information database according to the contractant ID and item purchase information extracted from said purchase information database of said contractant.

In this way, the contractant can figure out promptly whether the card of the contractant is misapplied by the others or not. Furthermore, the contractant can figure out how much the annuity point to be accumulated.

These usage details are often mailed to the user by a credit card company. However, the notification to the customer in the system of the present invention is not limited to mailing. A HTML file edited to web page form can be sent to said terminal according to an inquiry from a contractant terminal which is used by the contractant.

The method of making a computer operate as a system managing computer of said point annuity system can also achieve the object of the present invention.

### Effect of the Invention

The member stores do not need to develop, operate, or maintain the system of point service by themselves by using the system of the present invention since the system manages the point. This means that the member stores can freely adopt or abolish the point service. The member stores not adopting the point annuity service of the present invention can also do so in the system when the rate of the redeeming point is set 0%. That is, existing point service which used to be provided in each member store can be managed uniformly when the system of the present invention is adopted.

The contractant can increase an annuity amount linked with purchasing an item when used the system of the present invention. That is, the contractant can consume and save money at the same time, the contractant can allocate an after-tax income with well balance without any special intention. Since the more a person who enjoys a current consumption, the more the person increase the saving in the future, the system can achieve not “Work now, play late” but also “Play now, play later”.

Furthermore, the points obtained by a contractant are not limited to its use and is accumulated just like deposit and saving. In an existing point service, for example, a point obtained at a member store in a travel destination only once is not used or expired when the expiration date passes in the near future. However, the system of the present invention does not waste these kinds of point.

### BRIEF DESCRIPTION OF THE DRAWING

FIG. 1 is an entire diagram showing overview of the system to achieve a point annuity means according to the embodiment of the present invention.

FIG. 2 is a block diagram showing simply a function of a system managing computer according to the embodiment of the present invention.

FIG. 3 is a diagram showing a data structure and an example of a data of a contractant information database according to the embodiment of the present invention.

FIG. 4 is a diagram showing a data structure and an example of a data of a member store information database according to the embodiment of the present invention.

FIG. 5 is a diagram showing a data structure and an example of a data of a purchase information database according to the embodiment of the present invention.

FIG. 6 is a diagram showing a data structure and an example of a data of an annuity point information database according to the embodiment of the present invention.

FIG. 7 is a flowchart showing the flow of process of the system managing computer according to the embodiment of the present invention.

FIG. 8 is a diagram showing an existing point service.

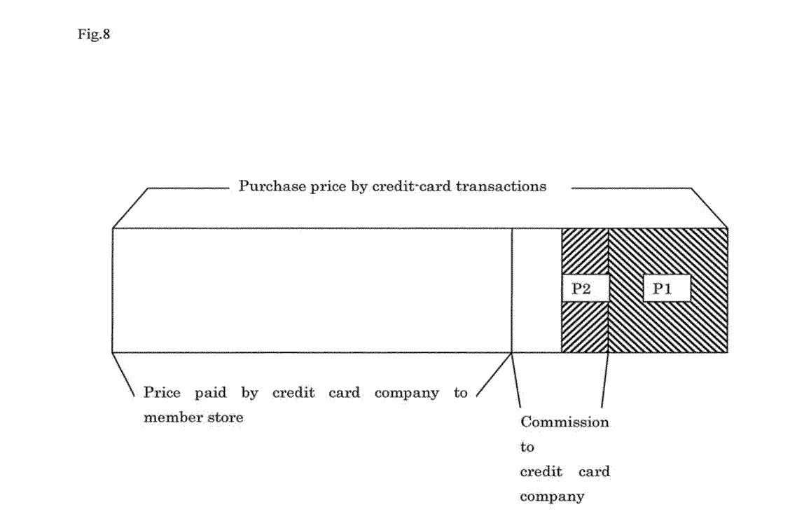

FIG. 9 is a diagram showing the point annuity service according to the present invention.

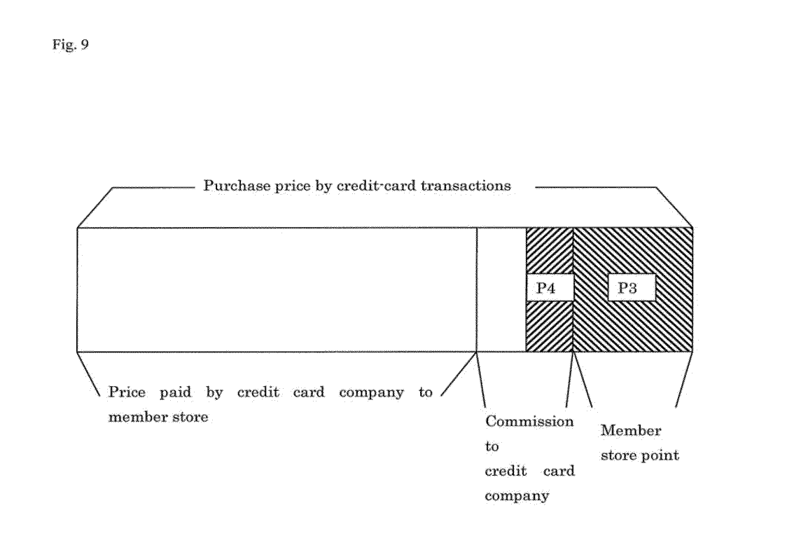

FIG. 10 is an entire diagram showing overview of the system to achieve a point annuity means according to another embodiment of the present invention.

FIG. 11 is a flowchart showing the flow of process according to the embodiment of the present invention.

FIG. 12 is a diagram showing an example of a constitution of SNS according to the embodiment of the present invention.

### BEST MODE FOR CARRYING OUT THE INVENTION

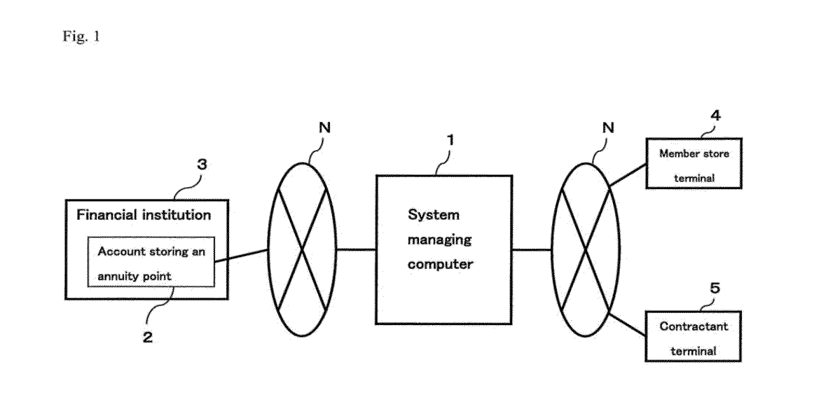

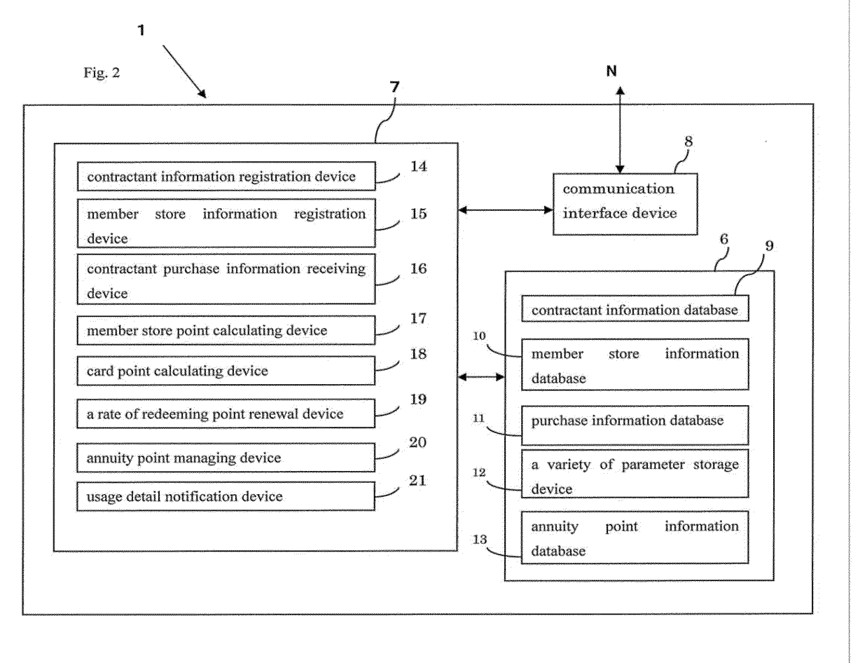

An embodiment of the present invention will be described below with reference to the drawings. FIG. 1 is an entire diagram showing overview of a system (hereinafter referred to as “the system”) according to this embodiment. FIG. 2 is a functional block diagram showing simply a constitution of a system managing computer used in the system.

A card issuer of the system of the present invention have to conduct a flow of process of money such as advancing the purchase amount of the contractant to the member store on behalf of the contractant and getting repaid by the contractant. It is quite important to be assessed what timings of this flow of process of money to accumulate points converted into an annuity in actually operating the system. However, since these do not relate to the present invention essentially, the flow of process of money is not specifically referred to in following embodiments.

Furthermore, a point accumulated by the system on behalf of a contractant is a resource which can be an annuity in the future. Therefore, it is preferable to be invested for long periods by a financial institution such as a trust bank, an insurance company and so on. However, since this does not relate to the present invention essentially either, it is not specifically referred to what kinds of financial institution, what kinds of type to be deposited, how to be invested and so on.

AS shown in FIG. 1, the system in the embodiment of the invention comprising:

a system managing computer 1 for stored various data and program needed in this system, a financial institution terminal 3 for opened an account accumulating an annuity point 2, a member store terminal 4 for used by stores adopted this system (hereinafter referred to “a member store”), a contractant terminal 5 for used by a consumer purchasing an item by credit-card transaction and making a contract with this system (hereinafter referred to “a contractant”). The system manage computer 1 is connected with the financial institution terminal 3, the member store terminal 4 and the contractant terminal 5 via a communication network NW so that information can be transceived.

The member store terminal 4 and the contractant terminal 5 may be a personal computer and a mobile phone, and may have an input means such as an entry keyboard and a mouse, and an output means such as a display and a printer. Furthermore, when the member store has a real store, since the contractant usually purchases an item by showing a credit card to a store staff, the member store terminal 4 is preferably capable of connecting with a card reader not shown.

Since it is convenience that transmission and reception of information can be performed via a web page between the contractant and the member store, and the system managing computer 1, it is preferable that the contractant terminal 5 and the member store terminal 4 have a screen display means and a software called a web browser.

This system managing computer 1 may be composed of a storage section 6, a processing section 7 and a network interface means 8, as shown in FIG. 2.

The storage section 6 may be composed of at least a contractant information database 9, a member store information database 10, a purchase information database 11, a variety of parameter storage device 12 and an annuity point information database 13. This storage section 6 may be implemented with a database server different from a hard disk drive device or the system managing computer 1.

The processing section 7 may be composed of at least a contractant information registration device 14, a member store information registration device 15, a contractant purchase information receiving device 16, member store point calculating device 17, card point calculating device 18, a rate of redeeming point renewal device 19, annuity point managing device 20 and usage detail notification device 21.

Each device of the processing section 7 is implemented in mainly not shown CPU running a prescribed program by reading a memory from memory medium such as CD-ROM

Furthermore, the system managing computer 1 stores HTML files described a not shown operating system, a variety of application program, a variety of data and a web page in a hard disk drive device or ram. Moreover, the system manage computer 1 also provides an input device as a keyboard or a mouse and an output device such as a display or a printer.

The function of the system manage computer 1 can be set in a plurality of computers. For example, the contract and the member store often communicate information via a web page. This web page can be managed by a web server prepared separately.

The contractant information registration device 14 receives attribute information regarding a contractant who purchase an item at a member store by credit-card transactions with the system and store these information liked with the contractant ID at the contractant information database 9. This contractant ID is issued based on a rule established in advance by contractant information registration device 14.

The attribute information regarding a contractant means a name, an address, date of birth, gender, information regarding an account used for paying for purchase money and so on. These are information which is normally made available at contracts. Furthermore, information of authentication is also registered timely.

A member store information registration device 15 receives information of an operator of the system (Credit-card company can be the operator.) or a member store which receives a settlement by a credit card company cooperating with the system, and stores these information with a member store ID given to the member store from the system in a member store information database 10. The member store ID issued based on a rule established in advance by the member store information registration device 15.

The information regarding the member store includes a name, a location, attribute information of said member store such as information regarding an account needed in settlement, and a rate of redeeming points of the member store point.

This is because the rate of redeeming points can vary depending on member stores.

A contractant purchase information receiving device 16 receives information sent from the member store terminal every time either contractant purchases an item at either member store.

The information to receive includes the member store ID of said member store, the contractant ID of said contractant and purchase information having a purchased item and purchased amount, and is stored in purchase information database 11.

The member store point calculating device 17 calculates the member store points by multiplying the purchase money by the rate of redeeming points configured according to each member store. The member store point is deducted from the purchase money.

A card point calculating device 18 calculates the card point by multiplying a commission paid from the member store calculated by multiplying the purchase money by rate of commission configured according to each member store by the rate of redeeming card point.

A rate of redeeming point renewal device 19 updates a rate of redeeming point of the member store information database 10 when receiving a notification of a change of a rate of redeeming point from the member store terminal 4.

An annuity point managing device 20 adds the member store point obtained by purchasing an item at a member store by a contract to a card point, and adds them to a present balance of an amount of annuity point stored in the annuity point information database 13. At a proper time, the annuity point managing device 20 gives an instruction to a financial institution which has the account to transfer the funds. The instruction is based on a treaty with the financial institution and the description of the instruction is omitted.

A usage detail notification device 21 notifies a record of purchase at a member store of a contractant and a present balance of an annuity point amount to said contract. In this case, the usage detail notification device 21 may respond an inquiry from individual contractant or may notify to all of the contractants regularly.

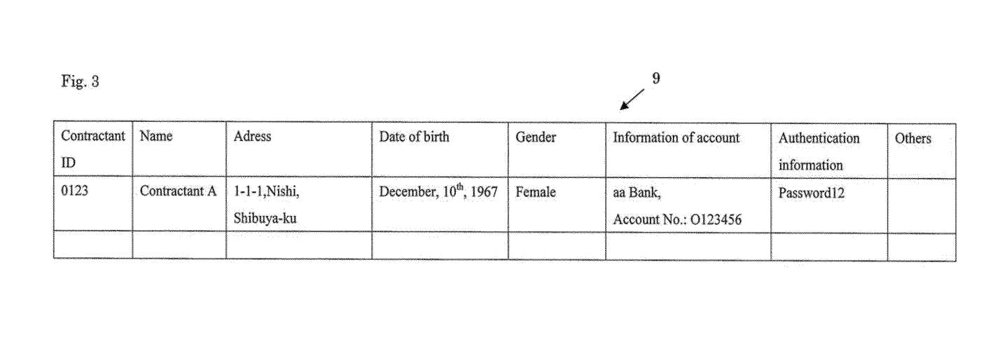

A contractant information database 9 stores a name, an address, date of birth, information regarding an account to charge purchase price linked with a contractant ID as shown in FIG. 3. Besides, PIN (personal identification number) to identify the contractant, authentication information such as fingerprint data and information needed (For example, a gender. Some member stores give preferential treatment to female customers.) is also stored in the contractant information database 9 from time to time.

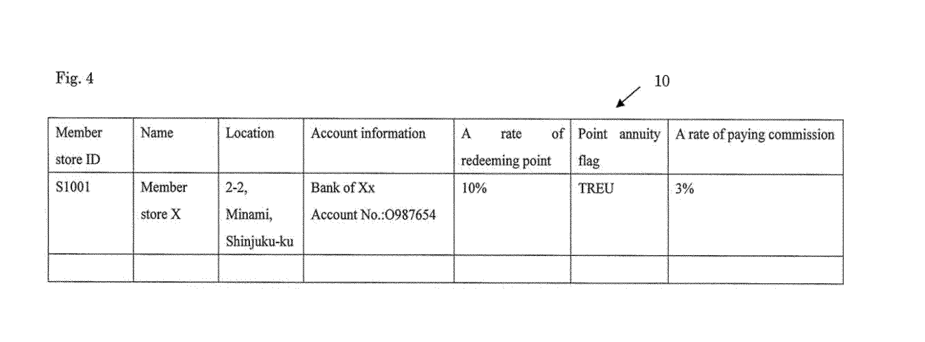

A member store information database 10 stores a name, a location, attribute information such as information regarding an account needed in settlement, and a rate of redeeming points linked with a member store ID as shown in FIG. 4. Furthermore, point annuity flag is also stored. When the member stores will provide their own point service with customers, they may not agree with converting points issued by them into annuity. Therefore, the flags which indicate whether point is converted into annuity will be set at each member store. Furthermore, the rate of a commission to pay the system or to the card issuer out of a price is also stored. This is because the rate can vary depending on member stores. Besides, information which recognizes to be a legitimate store is stored from time to time.

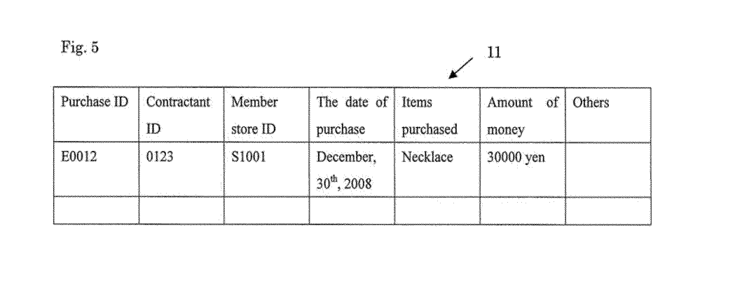

A purchase information database 11 stores a purchase ID given by the system and purchase information such as who/which member stores/what/how much to purchase as shown in FIG. 5.

A variety of parameter storage device 12 stores parameters which is needed in a process by the system managing computer 1. The parameters stored includes a rate of a card point returned to a contractant out of a commission paid from a member store.

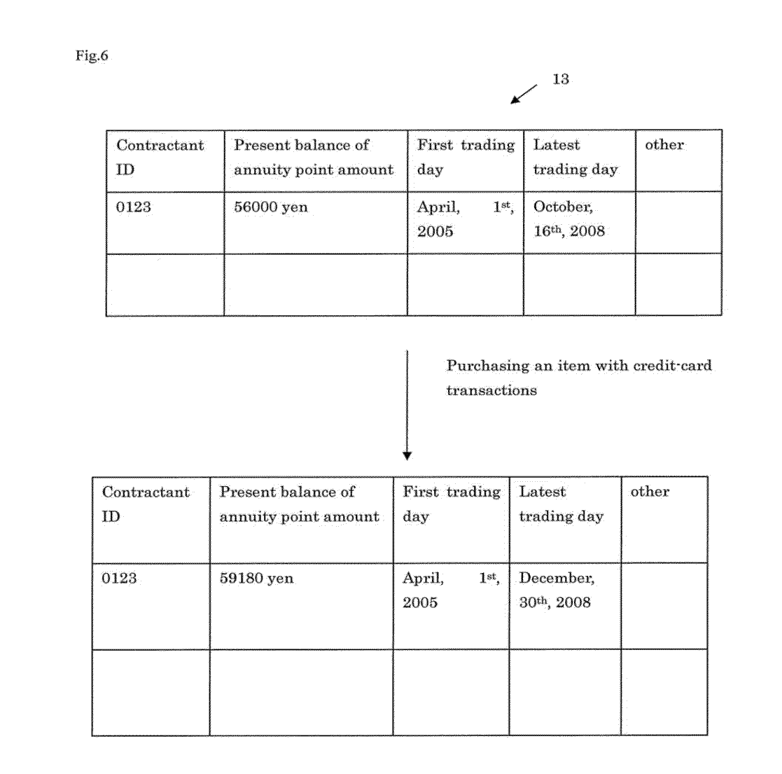

An annuity point information database 13 stores a present balance of an annuity point amount of each contractant as shown in FIG. 6.

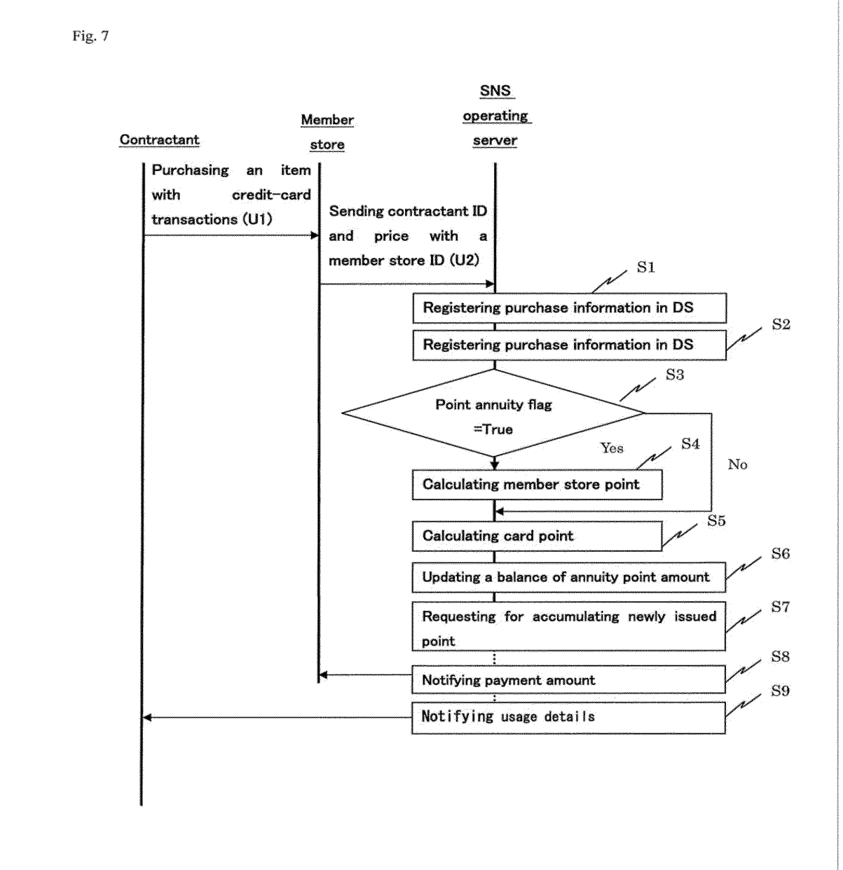

Next, the process of the system structured as described above is described with reference to FIG. 7. As used herein, this process is described under the assumption that a contractant A shown in FIG. 3 purchases an item at a member store X shown in FIG. 4. Furthermore, a present balance of annuity point amount of the contractant A is shown in upper FIG. 6.

As hereinafter defined, “U*” means a process by a user, that is a contractant or a member store, and “Step S*” means a process by the system managing computer 1.

A contractant A purchases an item at a member store X (Step [U1]). Forms of the purchase are not limited.

For example,

As for Example 1, a form where a contractant visits a real store and purchases an item, and shows a card for settlement at a payment and inputs an authentication information by the contractant to a member store terminal 4 which is connected to communicate with the system managing computer 1,
As for Example 2, a form where after decided an item to purchase a contractant inputs a contractant ID and an authentication information by the contractant to a member store terminal 4 which is connected to communicate with the system managing computer 1,
As for Example 3, a form where a contractant accesses to a shopping site opened by a member store by an own terminal 5, identifies an item to purchase and inputs a contractant ID and an authentication information,
may be applied.

The member store sends the contractant ID of the contractant who purchased an item and information such as an item purchased and its price with a member store ID to the system managing computer 1 (Step [U2]). The contractant purchase information receiving device 16 registers the received information in the purchase information database 11 (Step S1). In FIG. 5, the contractant A (Contractant ID=0123) purchased a necklace of 30000 yen on Dec. 30, 2008 at the member store X (Member store ID=S1001).

The member store point calculating device 17 extracts a point annuity flag and a rate of redeeming point of the member store on the basis of a member store ID sent from the member store information database 10 (Step S2). The member store point calculating device 17, when the point annuity flag is TRUE (Step S3 is YES.), multiply a price (In FIG. 5, 30000 yen) by a rate of redeeming (In FIG. 4, 10%) to calculate a member store point (Step S4). If the point annuity flag is FALSE (Step S3 is NO.), the member store point is not issued and the process of Step S5 will proceed.

Next, the card point calculating device 18 calculates a card point to be returned to a contractant by a card issuer (Step S5). The steps of calculating include extracting a rate of a commission paid according to a member store ID from the member store information database 10. In FIG. 4, this rate is 3% and a commission of the card issuer will be 900 yen (=30000 yen multiplied by 3%). Next, a card point to be returned to the contractant is calculated by multiplying a commission by this rate of redeeming according to the rate of redeeming of the card from a variety of parameter storage device 12. When the rate of redeeming of the card is 20%, the card point will be 180 yen (=900 yen multiplied by 20%).

When the card point is not issued by the card issuer, the rate of redeeming of the card is set 0%.

The annuity point managing device 20 extracts a present balance of an annuity point amount according to an contractant ID from the annuity point information database 13, adds this present balance to the amount of above added member store point and the card point of 3180 yen (=3000 yen+180 yen), and updates the present balance of the annuity point amount (Step S6). The updated annuity point information database 13 is shown in lower FIG. 6. A prescribed information is sent to a system of a financial institution so that the annuity point obtained by this purchase is accumulated to an account 2 (Step S7).

The system managing computer 1 notifies an amount paid to the member store (In this example, 26100 yen which is deducted 3000 yen of the member store points and 900 en of the commission from 30000 yen.), the date of payment and so on of the member store terminal 4 on a proper timely basis (Every time the contractant purchases an item, or in a lump of an amount of certain period of time) (Step S8).

Moreover, usage detail notification device 21 sends the annuity point amount obtained this time and buying history to the contractant terminal 5 (Step S9). Some of contractants do not have any mobile phones or personal computers. Thus, an account statement for mailing may be made on a prescribed timely basis and may be output the data made to printing device.

Also, a cancellation sometimes occurs after a purchase settlement. In this case, credit card companies usually make a minus settlement. However, a reduced process also should be made from the present balance of the annuity point account at the same time.

This is an epitome of processes from purchasing an item at a member store by a contractant to converting point into annuity to accumulate.

A rate of redeeming point of the member store is not always set a certain number of values. Depending on a season or on the day of the week, the rate can vary from time to time. However, everytime the rate changes, the member store terminal 4 sends the member store ID and the rate of redeeming after changing to the system managing computer 1. The rate of redeeming point renewal device 19 receives this and updates the value to the rate of redeeming the point in the member store information database 10.

Some of member stores, for example, can set a higher rate of redeeming to first and most important customers of the store than to other customers.

In that case, a data table of a member store ID, a contractant ID and a rate of redeeming point linked with each other is needed, however, the description will be omitted since this is just a design issue.

In above embodiments in the present invention, the annuity point amount is supposed to be deposited to a special account of a loan and trust company. However, the increase and decrease of the annuity point amount of each contractant may be managed only on a database by depositing an amount equivalent to an annuity point amount out of amount repaid to an account of a credit card company from a contractant directly to the account paid not transferred of funds to a special account.

In short, in the system of the present invention, it is important that the system accumulates the point which is obtained when a contractant of the system purchase an item at a member store and the point can be used to be withdrawn as well as deposit and saving in the future. Therefore, a data structure of database and a process flow is just an example and not limited.

Furthermore, in the system of the present invention, a contractant of the system can obtain a point by purchasing an item at a member store.

However, the member store may provide a link to a shopping site in a SNS site, be a user of the SNS site, and take a purchase from a contractant of the system at the same time. Hereinafter, an embodiment of this case will be described below.

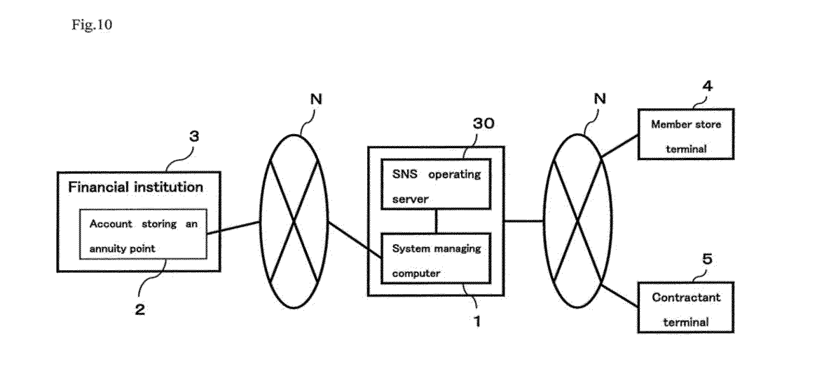

As shown in FIG. 10, the system in the embodiment comprising:

a system managing computer 1 storing a variety of data needed in the system and a program,
a financial institution terminal 3 opening an account storing an annuity point 2,
a member store terminal 4 used by the member store,
a contractant terminal 5 used by the contractant,
a SNS operating server 30 providing a SNS site.

The system managing computer 1 and the SNS operating server 30 communicate with the member store terminal 4 and the contractant terminal 5 via a communication network NW so that information can be transceived. Furthermore, at least the system managing computer 1 communicates with a financial institution terminal 3 via a communication network NW so that information can be transceived.

In the embodiment of the present invention, the system managing computer 1 and SNS operating server 30 are operated and managed by the same operator and are composed of a network such as LAN via a communication network NW so that information can be transceived. However, the operator does not have to be same to operate and manage.

Hereinafter, a structure of the system managing computer 1, the financial institution terminal 3, a member store terminal 4 and a contractant terminal is the same as above mentioned embodiment (As for the system managing computer 1, see FIG. 2.).

Furthermore, the SNS server 30 is composed of as it is called computer and has a resource needed to provide known SNS, a variety of data and program and so on.

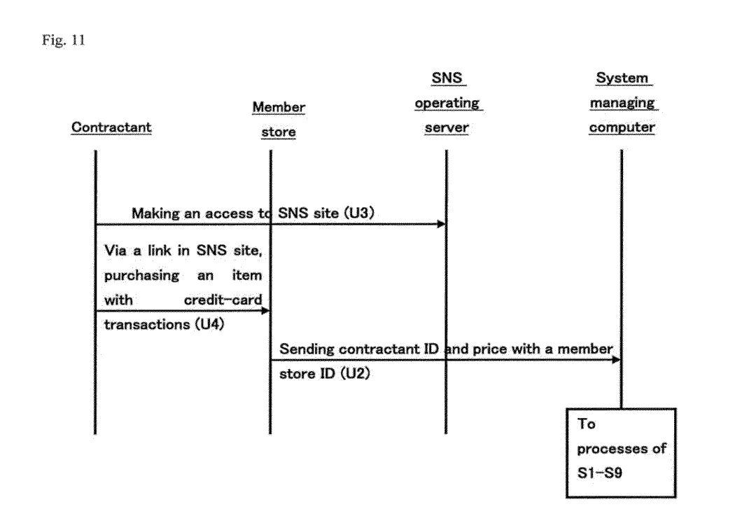

Next, a process of the system composed above will be described with reference to FIG. 11. The contractant makes an access to a SNS site (Step [U3]).

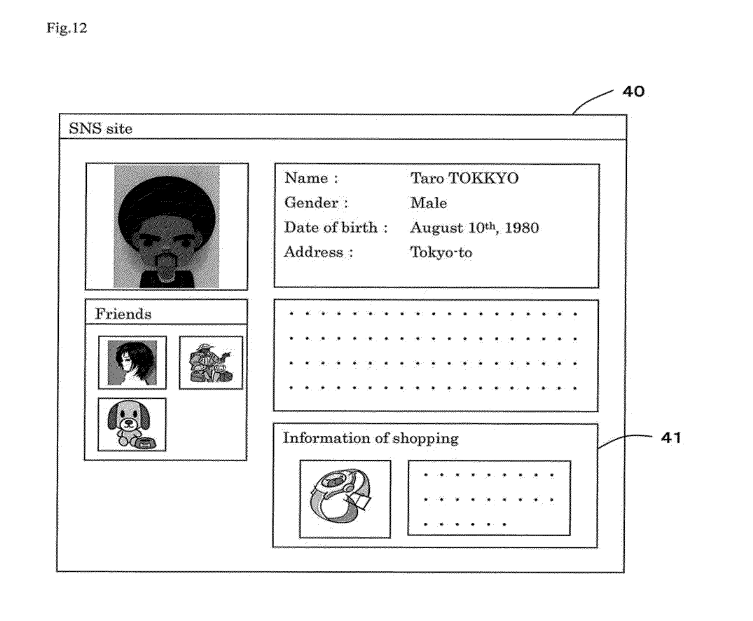

FIG. 12 shows an embodiment of this SNS site.

As shown in FIG. 12, a SNS site 40 has contents as a SNS site and an item information post section 41. The item information post section 41 establishes a link to the on-line shopping site by a member store.

A contractant who has an interest in the item makes an access to a web page for purchasing the item to click the link from the item information post section 41 and purchases the item at the member store (Step [U4]).

Forms of shopping is the same as the above embodiment, for example,

As for Example 1, a form where a contractant visits a real store and purchases an item, and shows a card for settlement at a payment and inputs an authentication information by the contractant to a member store terminal 4 which is connected to communicate with the system managing computer 1,
As for Example 2, a form where after decided an item to purchase a contractant inputs a contractant ID and an authentication information by the contractant to a member store terminal 4 which is connected to communicate with the system managing computer 1,
As for Example 3, a form where a contractant accesses to a shopping site opened by a member store by an own terminal 5, identifies an item to purchase and inputs a contractant ID and an authentication information,
may be applied.

The member store sends the contractant ID of the contractant who purchased an item and information such as an item purchased and its price with a member store ID to the system managing computer 1 (Step [U2]).

On the other hand, the system managing computer 1 executes programs of S1 to S9 above-mentioned and a point by shopping is converted into an annuity to accumulate.

In the present embodiment, in cooperation with a SNS site, a chance to shop where converting a point into an annuity is available can be increased.

In addition, in the present embodiment, the member store using the member store terminal 4 may be the operator itself of the SNS.

Furthermore, the SNS site operator may receive the member store point by shopping as a point for SNS.

When the system of the present invention becomes widely used, household finances in the nation's economy behaves in a rational manner to do consumption and saving at the same time automatically. This can respond to the demands of the present age of the breakaway from external demand dependent type economy.

### Key

1: system managing computer,
2: account storing a point,
3: financial institution
4: member store terminal,
5: conractant terminal,
6: storage section,
7: processing section,
8: communication interface device,
9: contractant information database,
10: member store information database,
11: purchase information database,
12: a variety of parameter storage device,
13: annuity point information database,
14: contractant information registration device,
15: member store information registration device,
16: contractant purchase information receiving device,
17: member store point calculating device,
18: card point calculating device,
19: a rate of redeeming point renewal device,
20: annuity point managing device,
21: usage detail notification device,
30: SNS operating server,
N: communication network,

1. A system converting a point into an annuity for accumulating a point of a member store according to each guest as a resource of a private annuity when a customer contacted credit-card transactions hereinafter called “contractant” purchases an item at the member store and paying an amount after deduction of contractant points from purchased amount to the member store comprising:
a system managing computer of this system capable of connecting with a member store terminal used by the member store via communication network;
a contractant information database storing attribute information of the contractant;
a member store information database storing attribute information of the member store and a rate of redeeming of point of the member store;
an information database of a point converting into an annuity storing information regarding a resource of a private annuity accumulated;
a contractant purchase information receiving device receiving purchase information including a purchase price as well as a contractant ID of the contractant purchasing an item and a member store ID of the member store from the member store terminal;
a member store point calculating device reading the rate of redeeming point of the member store linked the member store ID and multiplying by said purchase price to calculate the member store points: and
an annuity point managing device adding a balance of the point converting into an annuity stored in the information database of a point converting into an annuity linked the contractant ID of the contractant to the member store points to update the balance of the point converting into the annuity.

2. The system converting a point into an annuity according to claim 1, further comprising:
said member store information database also memorizing a rate of a commission paid by each of the member store to a card holder;
said system managing computer calculating the commission by adding said rate of the commission to said purchased price;
a card point calculating device calculating a card point adding the commission to prescribed rate of redeeming card point, wherein
said annuity point managing device adding a present balance of an amount of an annuity point memorized in said annuity point information database to a total said member store point and said card point to update the present balance of the amount of the annuity point.

3. The system converting a point into an annuity according to claim 1, further comprising:
said annuity point amount being managed to be deposited in an account of a financial institution,
said account of the financial institution is opened for each of the contractant.

4. The system converting a point into an annuity according to claim 1, further comprising:
said annuity point amount being deposited in a lump in an account of a financial institution,
said account of the financial institution being opened by said system,
a variation of the annuity point amount of each of the contractant being managed on said annuity point information database.

5. The system converting a point into an annuity according to any of claim 1, further comprising:
said member store information database comprising a point annuity flag linked with member store ID,
the point annuity flag is set TRUE when a point issued by said member store is converted into an annuity by said point annuity system is allowed and FALSE when a point issued by said member store is converted into an annuity by said point annuity system is not allowed;
said member store point calculating device calculating the member store point only when the point annuity flag is set TRUE.

6. The system converting a point into an annuity according to any of claim 1, further comprising:
said system managing computer receiving a change of the rate of redeeming points notified from a member store terminal,
a rate of redeeming point renewal device updating said member store information database to a content received.

7. The system converting a point into an annuity according to any of claim 1, further comprising:
said system managing computer further comprising a purchase information database memorizing an item purchase information comprising a member store ID and a contractant ID linked with a purchase ID;
a usage detail notification device notifying use information of the system comprising an annuity point amount extracted from said annuity point information database according to the contractant ID and item purchase information extracted from said purchase information database of said contractant.

8. A method converting a point into an annuity for accumulating a point of a member store according to each guest as a resource of a private annuity when a customer contacted credit-card transactions hereinafter called “contractant” purchases an item at the member store and paying an amount after deduction of contractant points from purchased amount to the member store, the method comprising the steps of:
a system managing computer of this system capable of connecting with a member store terminal used by the member store via communication network;
a contractant information database storing attribute information of the contractant;
a member store information database storing attribute information of the member store and a rate of redeeming of point of the member store;
an information database of a point converting into an annuity storing information regarding a resource of a private annuity accumulated;
a contractant purchase information receiving device receiving purchase information including a purchase price as well as a contractant ID of the contractant purchasing an item and a member store ID of the member store from the member store terminal;
a member store point calculating device reading the rate of redeeming point of the member store linked the member store ID and multiplying by said purchase price to calculate the member store points: and
an annuity point managing device adding a balance of the point converting into an annuity stored in the information database of a point converting into an annuity linked the contractant ID of the contractant to the member store points to update the balance of the point converting into the annuity.

9. The method converting a point into an annuity according to claim 8 further comprising:
memorizing a rate of a commission paid by each of the member store to a card holder in said member store information database;
further calculating calculating the commission by adding said rate of the commission to said purchased price by said system managing computer;
calculating a card point adding the commission to prescribed rate of redeeming card point by a card point calculating device, wherein
updating the amount of the annuity point adding not only said ember store point but also said card point to update an amount of an annuity point stored in said annuity point information database.
